(19) United States
(12) Patent Application Publication
(10) Pub. No.: US 2015/0208780 A1
(43) Pub. Date: Jul. 30, 2015

(54) Luggage Mountable Hand Truck

(71) Applicant: Randy A. Avery, Port Orchard, WA (US)

(72) Inventor: Randy A. Avery, Port Orchard, WA (US)

(21) Appl. No.: 14/311,602

(22) Filed: Jun. 23, 2014

Related U.S. Application Data
(60) Provisional application No. 61/932,413, filed on Jan. 28, 2014.

(51) Int. Cl. A45C 13/38; B62B 1/06; B62B 5/06; B62B 1/04

(52) U.S. Cl. CPC A45C 13/385; B62B 1/042; B62B 1/06; B62B 5/06

(57) ABSTRACT

A luggage mountable hand truck, which provides a user with enhanced cargo transportation capabilities, is provided with a collapsible design. The collapsible design allows the profile of the luggage mountable hand truck to be drastically reduced when not in use. The apparatus utilizes a pair of telescoping legs which allows the overall height of the apparatus to be altered. The luggage mountable hand truck can be used in two distinct modes, either as a standalone hand truck, or attached to an luggage item which already has some sort of wheel mechanism. Attachment to the luggage item is achieved through several straps which are wrapped around the luggage item; vertical support is provided by a base plate which contacts the top of the luggage item while a base plate allows objects to be stacked onto the luggage mountable hand truck for easy transportation by the user.

The current application claims a priority to the U.S. Provisional Patent application Ser. No. 61/932,413 filed on Jan. 28, 2014.

### FIELD OF THE INVENTION

The present invention relates generally to object transportation hand trucks. More specifically, the present invention is a hand truck which can be utilized individually as a hand truck, or can be mounted to a piece of luggage to supplement the object transportation capabilities of that piece of luggage. The present invention is also capable of folding down to decrease its profile and make it easier to transport.

### BACKGROUND OF THE INVENTION

The modern world is globalized and connected in a way which has never been accomplished before. As a result of this fact, companies, families, and friends can be spread out across entire countries or even across the entire world. Companies may maintain branches in various parts of a country or even in different countries in order to facilitate manufacture and distribution of their products. Families and friends often spread out across a country in pursuit of jobs, careers, and personal goals. Modern communications and information exchange technologies such as telephones and the internet allow for various branches of a company and friends and family to keep in touch with one another despite vast distances between them. However, despite the effectiveness of modern communications and information exchange, it is often beneficial or desired for face to face meetings to take place. This is particularly true with friends and family. Resultantly, there is a massive travel network in the modern world which enables people to relocate themselves from one position to another, and then back again.

The modern travel network operates using a plurality of different transportation means including ground vehicles, air vehicles, and marine vehicles. Ground vehicles such as cars and trucks are often privately owned and utilized for personal transport for going relatively short distances. Air vehicles such as commercial airliners are typically owned and operated by companies and are typically used for very long range travel. Marine vehicles are also typically commercially owned and are usually used for bulk goods transport, or for large scale passenger transport. Regardless of the mode of transportation, a person who is travelling to some location for a temporary visit typically needs to bring along some vital personal affects. Such vital personal affects typically include, but are not limited to clothing, personal computers, personal communications devices, and personal hygiene products. Typically, such vital personal effects are transported in storage bags specialized for travelling which are colloquially known as luggage bags. There is an extremely wide range of luggage bags which vary in both size and functional capabilities. For example, some luggage bags are small and simple with only a few storage compartments secured by zippers and some handles or a shoulder strap to carry the bag. Other luggage bags are large rectangular bags which have built in wheels and an extendable handle to allow a user to easily roll the bag behind them. Such rolling luggage bags are often utilized by those who travel by airplane as the bags are easy to roll through large modern airports.

The amount of luggage which one traveler takes with them may vary greatly depending on a number of factors including how long the traveler intends to stay at their destination, and the purpose of their visit. Often, lone travelers may have multiple luggage bags which they must carry with them; this can become increasingly difficult as the number of bags increases. One or two bags is very easy to manage, particularly if one bag is small and can be carried in conjunction with another luggage bag; this is often the case with small bags known as carry-ons which are common in flight travel. Exceeding this number may cause great difficulty for the traveler, often requiring them to seek assistance, or find transport carts in order to move all of their luggage. Unfortunately, assistance can be unreliable, and transport carts can sometimes be difficult to find even in airports, or may require the traveler to pay some fee as collateral with a portion being returned when the cart is returned. It is clear that there is a need for an apparatus which can eliminate the shortcomings mentioned above while still allowing the user to mobilize a large number of luggage bags with ease.

It is resultantly the object of the present invention to introduce a luggage mountable hand truck. It is a further object of the present invention to improve greatly upon currently existing hand truck designs by providing a unique set of functionality which is specifically tailored to travelling and interfacing with luggage bags. It is an object of the present invention to provide functionality which allows the present invention to be attached to a luggage bag to effectively allow that luggage bag to carry other luggage bags without any manual intervention from the user. The present invention is also capable of folding down or collapsing such that its profile is greatly reduced. This allows the present invention to be transported with great ease.

### BRIEF DESCRIPTION OF THE DRAWINGS

FIG. 1 is a perspective view of the present invention;

FIG. 2 is a front view of the present invention;

FIG. 3 is a right side view of the present invention;

FIG. 4 is a left side view of the present invention;

FIG. 5 is a top view of the present invention;

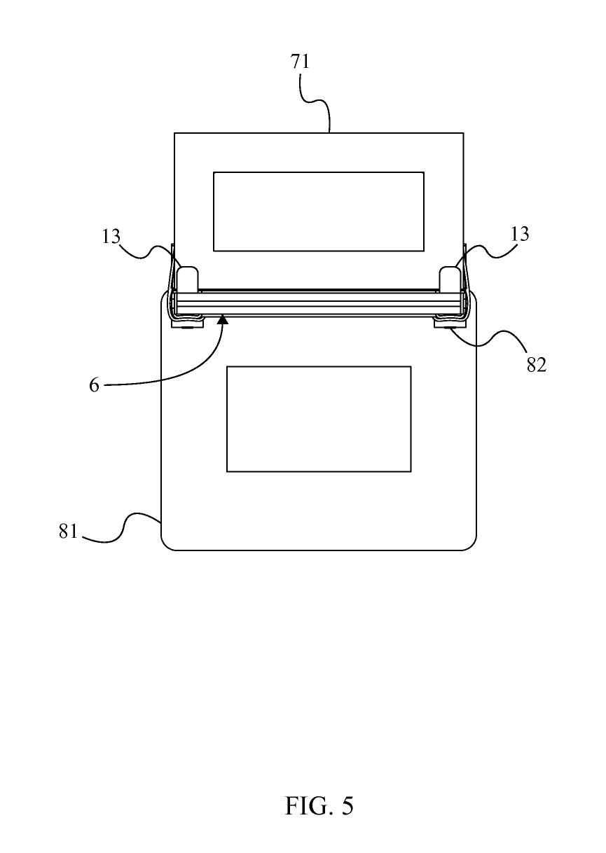

FIG. 6 is a bottom view of the present invention.

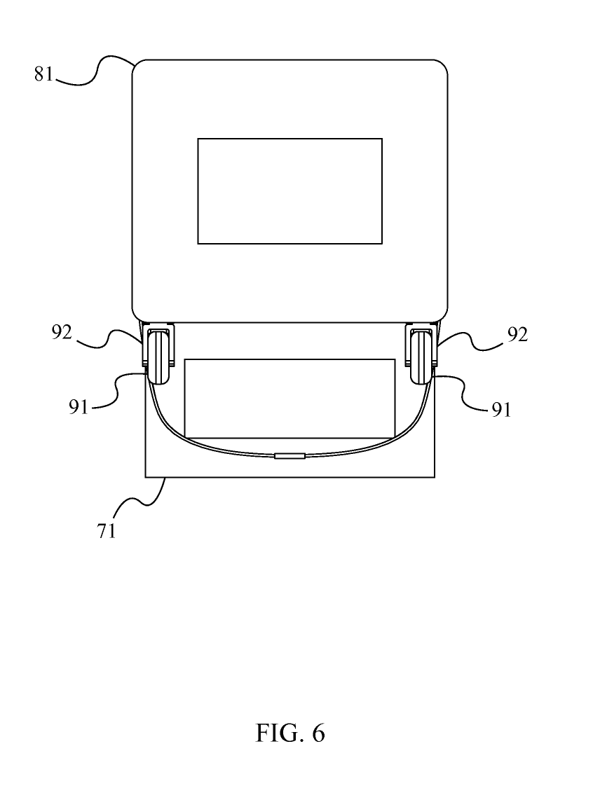

FIG. 7 is a perspective view of the present invention in the collapsed configuration;

FIG. 8 is a front view thereof;

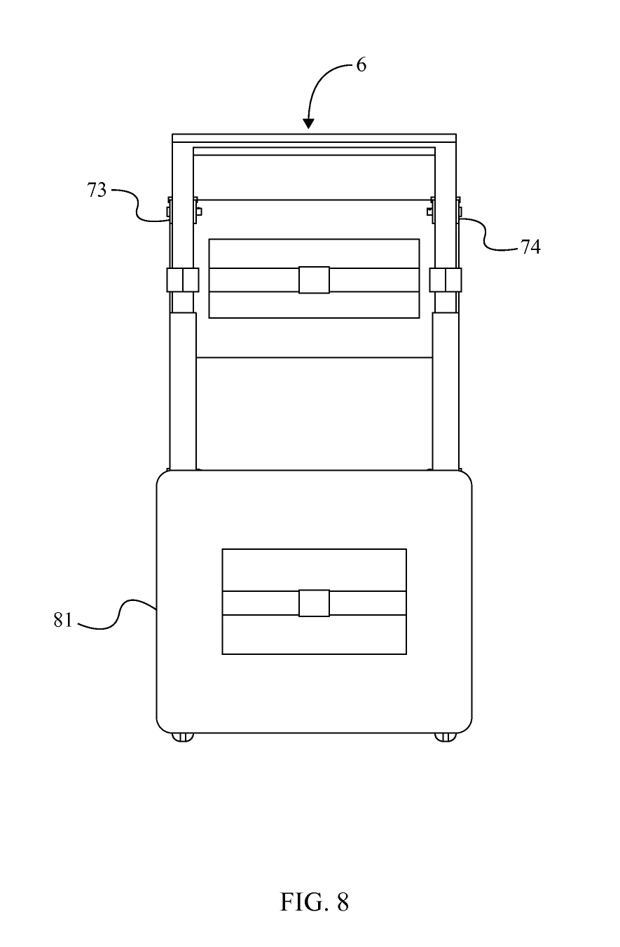

FIG. 9 is a rear view thereof.

FIG. 10 is a perspective view of the present invention with the plurality of adjustable straps with the left and right strap decoupled from one another;

FIG. 11 is a front view thereof;

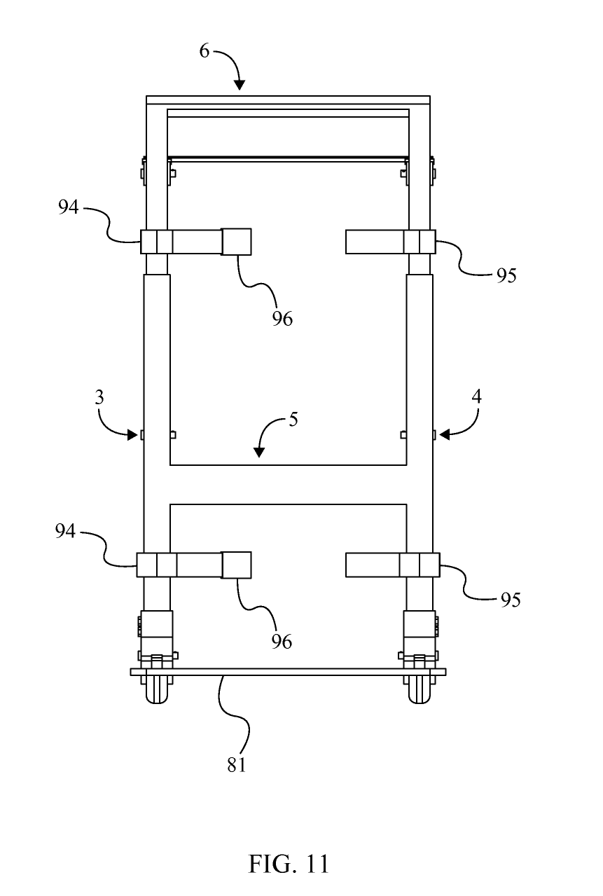

FIG. 12 is a rear view thereof;

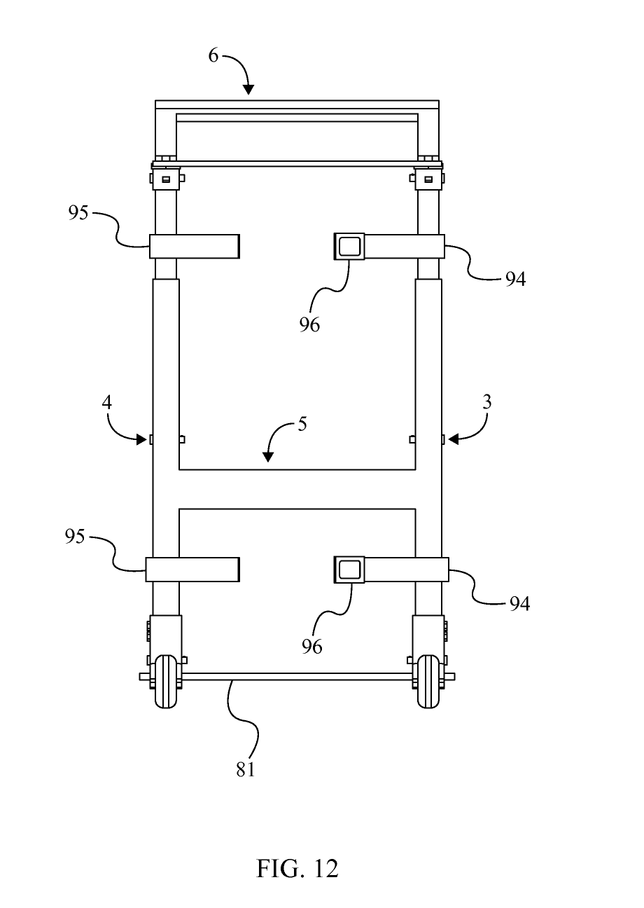

FIG. 13 is a rear perspective view thereof;

FIG. 14 is a partially exploded perspective view thereof;

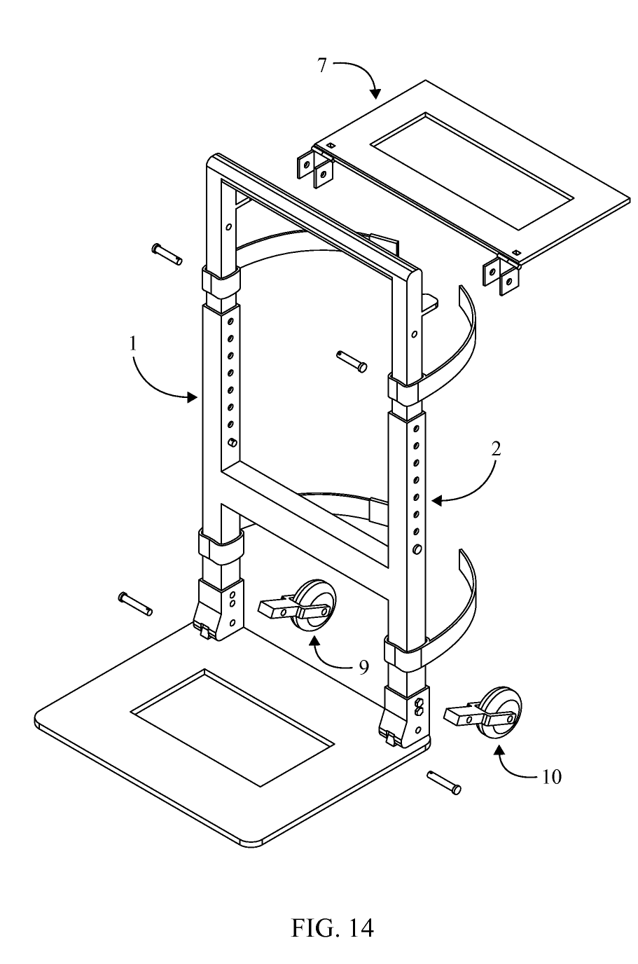

FIG. 15 is a right side view thereof.

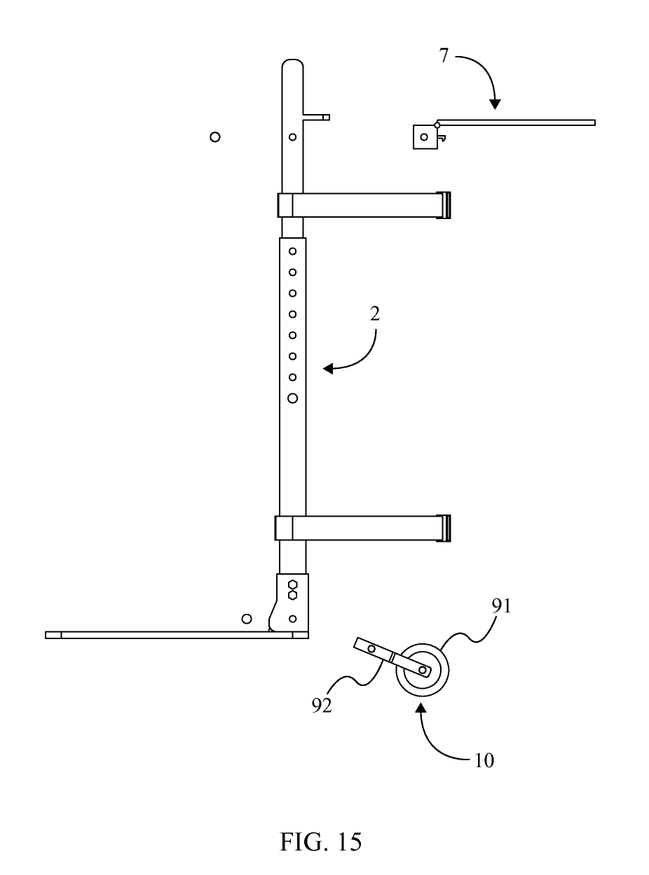

FIG. 16 is another exploded perspective view of the present invention.

### DETAILED DESCRIPTIONS OF THE INVENTION

All illustrations of the drawings are for the purpose of describing selected versions of the present invention and are not intended to limit the scope of the present invention.

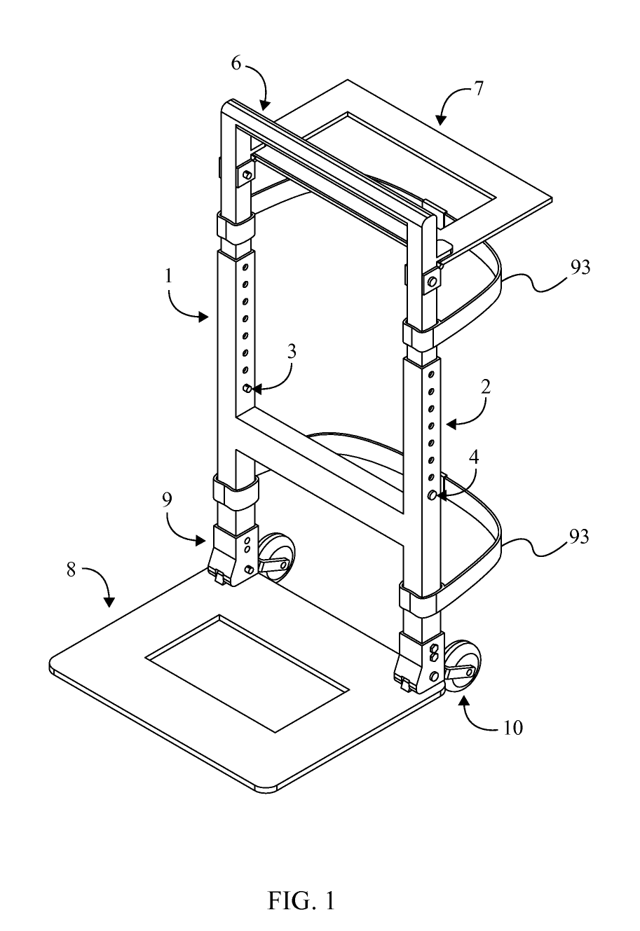

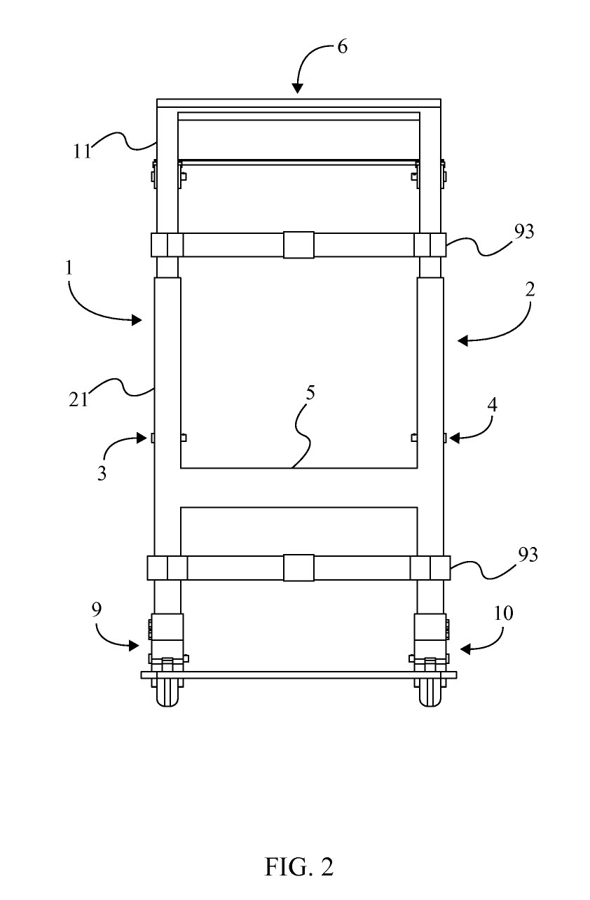

The present invention is a luggage mountable hand truck, as can be observed in FIG. 1, and FIG. 2. The present invention is an apparatus which provides the user with the possibility to easily carry luggage items. The ease with which the luggage items are carried is facilitated by placing these luggage items onto the present invention which is equipped with wheels to allow the user to pull the luggage with minimal effort. The present invention is also capable of being mounted directly to an already existing luggage bag, preferably one which is equipped with wheels that allow the luggage bag to roll along a ground surface. In such a situation with the present invention is attached to an already existing wheel equipped luggage, the present invention provides a platform upon which further luggage items can be placed. Further luggage items which are placed on the present invention are thereby mounted to the luggage by way of the present invention. Thus, when the user pulls the wheel equipped luggage, they also pull the present invention and any other luggage resting thereon.

The present invention comprises a left telescoping leg 1, a right telescoping leg 2, a stabilizing bar 5, a handle 6, a back plate assembly 7, and a base plate assembly 8. The left telescoping leg 1 and the right telescoping leg 2 are oriented parallel relative to one another, as can be observed in FIG. 1. Additionally, the left telescoping leg 1 and the right telescoping leg 2 are offset from one another by some distance. The parallel orientation and distance offset between the left telescoping leg 1 and the right telescoping leg 2 creates the basic frame of the present invention upon which other components are mounted. Additionally, the left telescoping leg 1 and the right telescoping leg 2 are adjustable in length. During operation of the present invention, the length of the left telescoping leg 1, and the right telescoping leg 2 can be altered, and the left telescoping leg 1 and the right telescoping leg 2 must be aligned along parallel paths in order for the present invention to function properly. The left telescoping leg 1 and the right telescoping leg 2 are connected to one another by way of both the stabilizing bar 5 and the handle 6. The stabilizing bar 5 is connected to both the left telescoping leg 1 and the right telescoping leg 2, and is oriented perpendicular to both. Thus, the stabilizing bar 5 is located in between, and is connected to both the left telescoping leg 1 and the right telescoping leg 2, as can be observed in FIG. 2. The primary purpose of the stabilizing bar 5 is to link the left telescoping leg 1 and the right telescoping leg 2 together by way of a rigid connection. Thus, the position of the left telescoping leg 1 and the right telescoping leg 2 are held fixed relative to one another.

The handle 6 is also connected in between the left telescoping leg 1 and the right telescoping leg 2, as can be observed in FIG. 2. The handle 6 is connected near the top of both the left telescoping leg 1 and the right telescoping leg 2. Furthermore, the handle 6 is oriented such that the handle 6 is perpendicular to both the left telescoping leg 1 and the right telescoping leg 2 while being parallel to the stabilizing bar 5. Thus, the handle 6 follows a path which exactly parallel to the stabilizing bar 5. The intended function of the handle 6 is to allow the user to easily grasp the present invention, and thereby pull the present invention along behind them, or push the present invention in front of them. The handle 6 comprises a solid structural element of manufactured from some rigid material which is ergonomically shaped in order to facilitate grasping of the handle 6 by the user of the present invention. The exact shape and dimension of the handle 6 may vary in the final embodiment of the present invention.

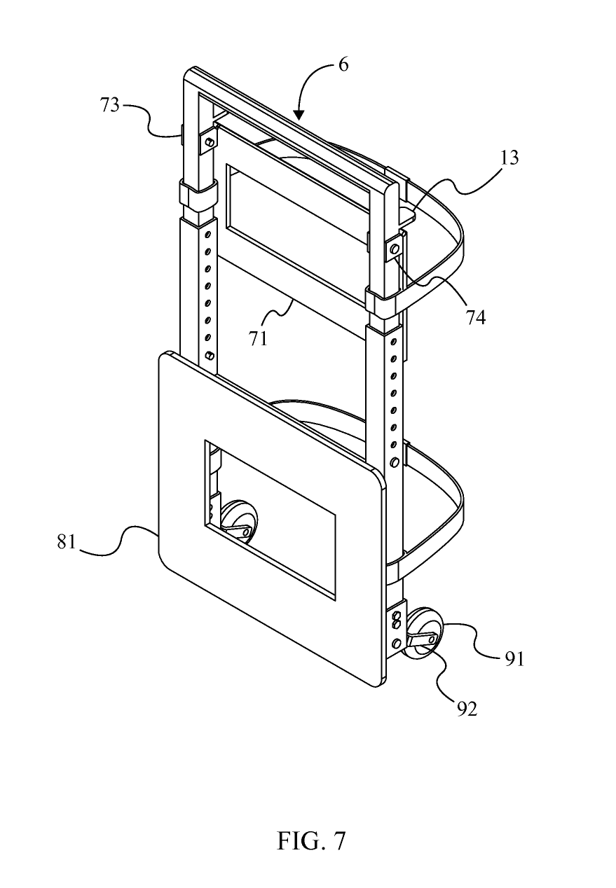

The back plate assembly 7 comprises a back plate 71, a left plate mount 73, and a right plate mount 74. The left plate mount 73 is attached to the left telescoping leg 1 while the right plate mount 74 is attached to the right telescoping leg 2 as can be observed in FIG. 7. The left plate mount 73 and the right plate mount 74 can both be removed from their respective telescoping leg. The primary purpose of both the left plate mount 73 and the right plate mount 74 is to provide a way for the back plate 71 to be attached to the left telescoping leg 1 and the right telescoping leg 2. The back plate 71 is hingedly connected to both the left plate mount 73 and the right plate mount 74. This hinged connection between the back plate 71, the left plate mount 73, and the right plate mount 74, enables the back plate 71 to rotate relative to the right plate mount 74 and the left plate mount 73, thereby rotating relative to the left telescoping leg 1 and the right telescoping leg 2. The rotation of the back plate 71 relative to the left telescoping leg 1 and the right telescoping leg 2 allows the back plate 71 to be opened or closed, allowing the present invention to have two configurations; one collapsed, which can be observed in FIG. 7, and one functional, which can be observed in FIG. 1. The purpose of the two different configurations is to allow the present invention to be lower profile and therefore take up much less space when the present invention is not in use.

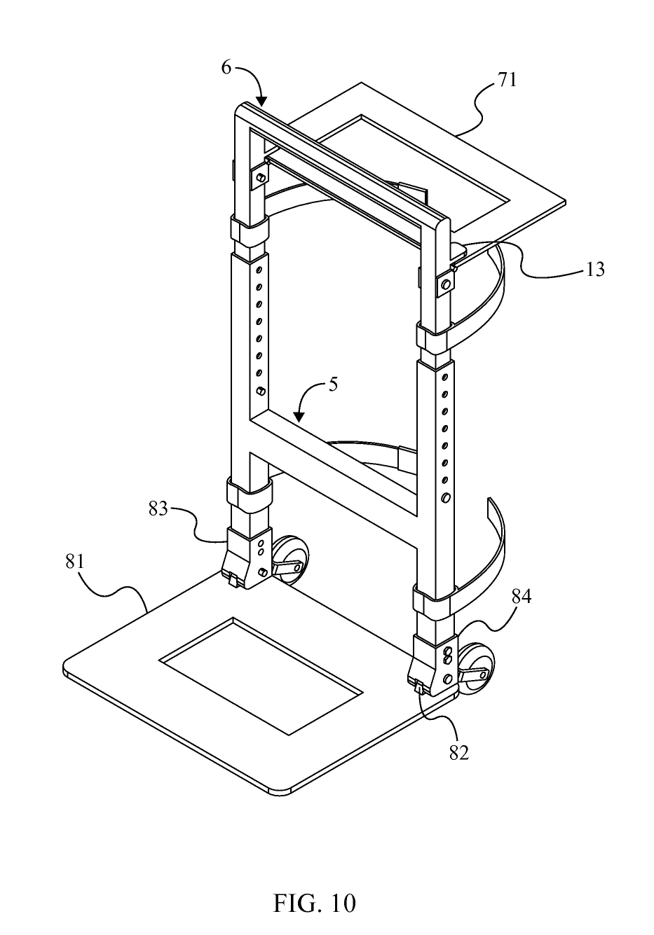

The base plate assembly 8 comprises a base plate 81, a left base mount 83, and a right base mount 84. The left base mount 83 is connected to the left telescoping leg 1, while the right base mount 84 is connected to the right telescoping leg 2. The left base mount 83 and the right base mount 84 are connected at one end of the left telescoping leg 1 and the right telescoping leg 2 respectively, as can be observed in FIG. 10. The base plate 81 is hingedly connected to both the left base mount 83 and the right base mount 84. The hinged connection between the base plate 81, the left base mount 83, and the right base mount 84 enables the base plate 81 to rotate relative to both the left base mount 83 and the right base mount 84. By allowing the rotation of the base plate 81, the present invention is enabled to transition between the collapsed and the functional configurations. In the collapsed configuration which can be seen in FIG. 7, the present invention is much lower profile, allowing the present invention to be stored conveniently in small areas.

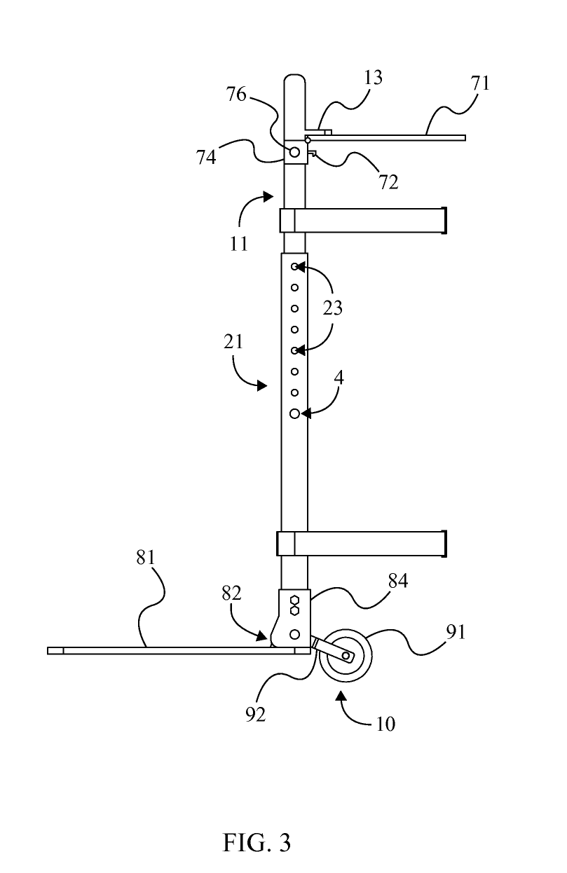

The left base mount 83 is positioned opposite to the handle 6 along the left telescoping leg 1, as can be observed in FIG. 10. The right base mount 84 is similarly positioned opposite the handle 6 along the right telescoping leg 2. This positioning ensures that the left base mount 83 and the right base mount 84 are at the opposite ends of the left telescoping leg 1 and the right telescoping leg 2 respectively; this orientation can be observed in FIG. 3. The left base mount 83 and the right base mount 84 must be positioned opposite the handle 6, such that the base plate 81 is also located opposite the handle 6. The stabilizing bar 5 is connected to both the left telescoping leg 1 and the right telescoping leg 2. The connection between the left telescoping leg 1 and the stabilizing bar 5 is located between the handle 6 and the left base mount 83. Similarly, the connection between the right telescoping leg 2 and the stabilizing bar 5 is positioned along the right telescoping leg 2 between the right base mount 84 and the handle 6. Referencing FIG. 2, the resultant position of the stabilizing bar 5 helps to ensure structural integrity of the present invention, even when the present invention is used to support significant loadings.

The left telescoping leg 1 and the right telescoping leg 2 of the present invention each comprise an upper section 11 and a lower section 21. Each upper section 11 further comprises an upper pin hole 12 and a back stop 13. The upper pin hole 12 traverses perpendicularly through the upper section 11. The upper pin hole 12 is also aligned parallel to the handle 6. The upper pin hole 12 is present to allow some pin component to traverse through the upper section 11. The exact dimensions and positioning of the upper pin hole 12 are subject to change in the final embodiment of the present invention. The back stop 13 is positioned perpendicularly to the upper section 11, and is also adjacent to the back plate 71, as can be observed in FIG. 3. Furthermore, the back stop 13 protrudes out from the upper section 11 some distance, such that a significant area of the back stop 13 can interface with the back plate 71. The primary purpose of the back stop 13 is to come into direct physical contact with the back plate 71 as can be seen in FIG. 10. The physical contact between the back stop 13 and the back plate 71 prevents the back plate 71 from rotating past ninety degrees relative to the left telescoping leg 1 and the right telescoping leg 2. The back plate 71 is perpendicular to the left telescoping leg 1 and the right telescoping leg 2 when the present invention is in the functional configuration. The upper pin hole 12 and the back stop 13 are offset from one another by some distance along the upper section 11. Thus, the upper pin hole 12 is closer to one end of the upper section 11 while the back stop 13 is closer to the other end of the upper section 11. The exact offset distance between the upper pin hole 12 and the back stop 13 is subject to change in the final embodiment of the present invention.

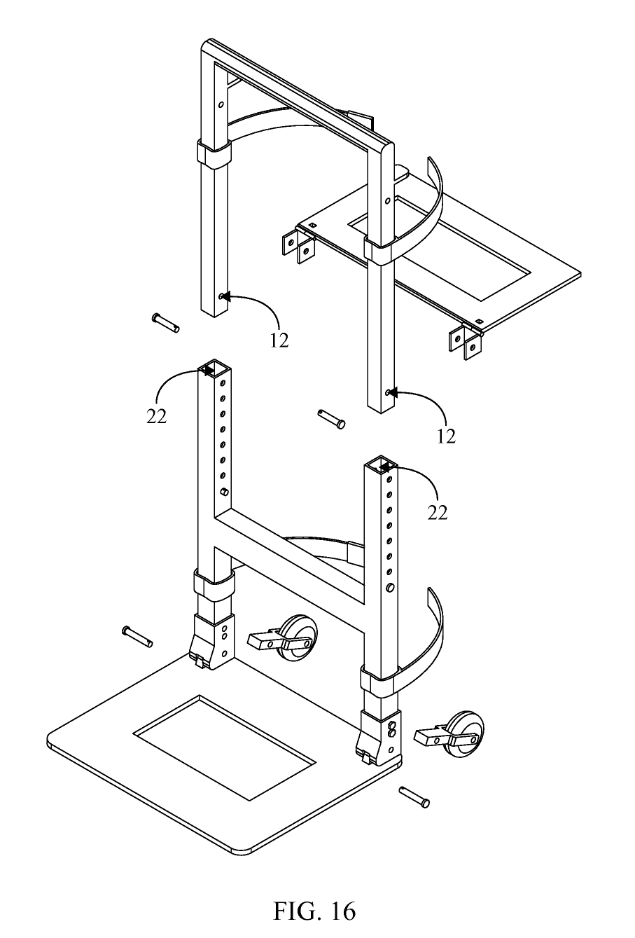

The lower section 21 of the present invention further comprises a central channel 22 and a plurality of lower pin holes 23. The central channel 22 traverses partially into the lower section 21. The cross sectional shape of the central channel 22 matches the cross sectional shape of the upper section 11, thereby facilitating the insertion of the upper section 11 into the lower section 21. Some distance of the upper section 11 and the lower section 21 overlaps when the present invention is fully assembled. This overlap distance can be altered, thus altering the overall length of the left telescoping leg 1 and the right telescoping leg 2. As the upper section 11 of both the left telescoping leg 1 and the right telescoping leg 2 are joined together by the handle 6, the overlap distance within the left telescoping leg 1 and the right telescoping leg 2 is identical between both. Therefore, when the total length of the left telescoping leg 1 is altered, the length of the right telescoping leg 2 is also altered by the exact same amount, and vice versa. The plurality of lower pin holes 23 traverses entirely through the lower section 21 and the central channel 22. The plurality of lower pin holes 23 is aligned perpendicular to lower section 21 and parallel to the stabilizing bar 5. Thus, the plurality of lower pin holes 23 is aligned parallel to the upper pin hole 12 when the upper section 11 is inserted into the central channel 22, as can be observed in FIG. 16. The plurality of lower pin holes 23 is distributed evenly along the length of the central channel 22. The spacing between each of the plurality of lower pin holes 23 is subject to change in the final embodiment, and may be dependent upon how many iterations are present in the plurality of lower pin holes 23. The purpose of the plurality of lower pin holes 23 is to allow a left adjustment pin 3 to be inserted into the left telescoping leg 1 and a right adjustment pin 4 to be inserted into the right telescoping leg 2. The left adjustment pin 3 and the right adjustment pin 4 traverse through the upper section 11 and the lower section 21 thereby locking the upper section 11 and the lower section 21 relative to one another.

The upper section 11 traverses into the central channel 22 found on the lower section 21. The end of the upper section 11 which is closer to the upper pin hole 12 is the end which is inserted into the central channel 22. The insertion of the upper section 11 into the lower section 21 allows the left telescoping leg 1 and the right telescoping leg 2 to be completely assembled, as can be observed in FIG. 16. Thus, when the upper section 11 is inserted into the central channel 22, a desired lower pin hole of the plurality of lower pin holes 23 can be aligned with the upper pin hole 12 of the upper section 11. The adjustment pin can then be inserted through the lower section 21 and the upper section 11, locking the two components in position with one another through the desired lower pin hole and the upper pin hole 12. The primary purpose of this is to allow the left telescoping leg 1 and the right telescoping leg 2 to have adjustable lengths. The length of both the left telescoping leg 1 and the right telescoping leg 2 can be altered by changing the distance by which the upper section 11 is inserted into the lower section 21. The desired lower pin hole can then be aligned with the upper pin hole 12, and the adjustment pin inserted therein. Thus, the length of both the left telescoping leg 1 and the right telescoping leg 2 can be adjusted to one of a plurality of discrete lengths which are defined by the amount of overlap between the upper section 11 and the lower section 21, and the plurality of lower pin holes 23.

The luggage mountable hand truck further comprises a left adjustment pin 3 in order to facilitate locking of the length of the left telescoping leg 1. The luggage mountable hand truck also comprises a right adjustment pin 4 which facilitates locking of the length of the right telescoping leg 2. The left adjustment pin 3 is positioned into the desired lower pin hole and the upper pin hole 12 of the left telescoping leg 1. The interface between these three components results in the upper section 11 and the lower section 21 of the left leg being fixed in position relative to one another. This results in the locking of the length of the left telescoping leg 1. The right adjustment pin 4 is positioned into the desired lower pin hole and the upper pin hole 12 of the right telescoping leg 2. The interface between these three components results in the upper section 11 and the lower section 21 of the right leg to be fixed in position relative to one another. This results in the locking of the length of the right telescoping leg 2. The left adjustment pin 3 and the right adjustment pin 4 can be removed from the left telescoping leg 1 and the right telescoping leg 2 at any time; this allows for adjustment of the length of the left telescoping leg 1 and the right telescoping leg 2, once the left adjustment pin 3 and the right adjustment pin 4 are reinserted into the corresponding pin holes, the left telescoping leg 1 and the right telescoping leg 2 are once again locked at a specific length.

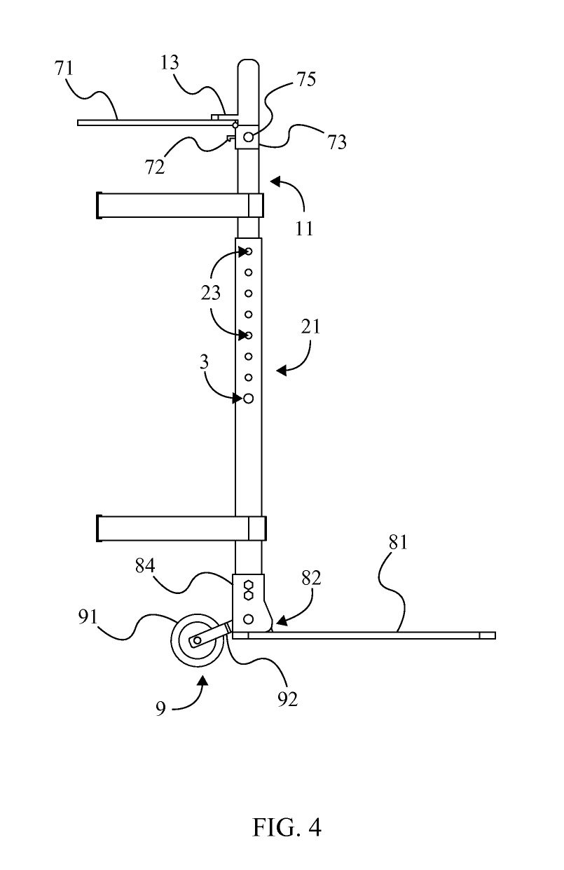

The left wheel assembly 9 and the right wheel assembly 10 of the present invention each comprise a wheel 91 and a wheel mount 92. The wheel is rotatably connected into the wheel mount 92. This allows the wheel 91 to rotate freely about one axis relative to the wheel mount 92. The wheel 91 is positioned adjacent to the base plate 81, as can be observed in FIG. 7. This positioning of the wheel 91 enables the wheel 91 to make contact with the ground, while the rest of the present invention, such as the base plate 81, the left telescoping, and the right telescoping leg 2 can be tilted relative to the ground upon which the wheel 91 rests. The wheel 91 rotates relative to the wheel mount 92, thereby allowing the present invention to be rolled easily across the ground or other surface by way of the wheel 91 assembly. The wheel mount 92 of the left wheel assembly 9 is attached to the left base mount 83, as can be seen in FIG. 4. This positioning provides the necessary location for the wheel 91 to be in contact with the ground and allow the present invention to be rolled over the ground or other surface. The left wheel assembly 9 is similarly attached to the right base mount 84, as can also be seen in FIG. 3. Again, the positioning is intended to allow the wheel 91 to make contact with the ground and allow a user to easily roll the present invention over the ground or other surface. The wheel mount 92 of the left wheel assembly 9 is removably attached to the left base mount 83 while the wheel mount 92 of the right wheel assembly 10 is removably attached to the right base mount 84; this enables the left wheel assembly 9 and the right wheel assembly 10 to be removed from their respective base mounts. Removal of the left wheel assembly 9 and the right wheel assembly 10 is enabled as a function as the present invention may be mounted to a luggage item which already has wheels; in such a situation, the wheels 91 located on the present invention would be useless, and may actually obstruct the present invention from being mounted to the luggage. Thus, the left wheel assembly 9 and the right wheel assembly 10 are fully removable from the left base mount 83 and the right base mount 84.

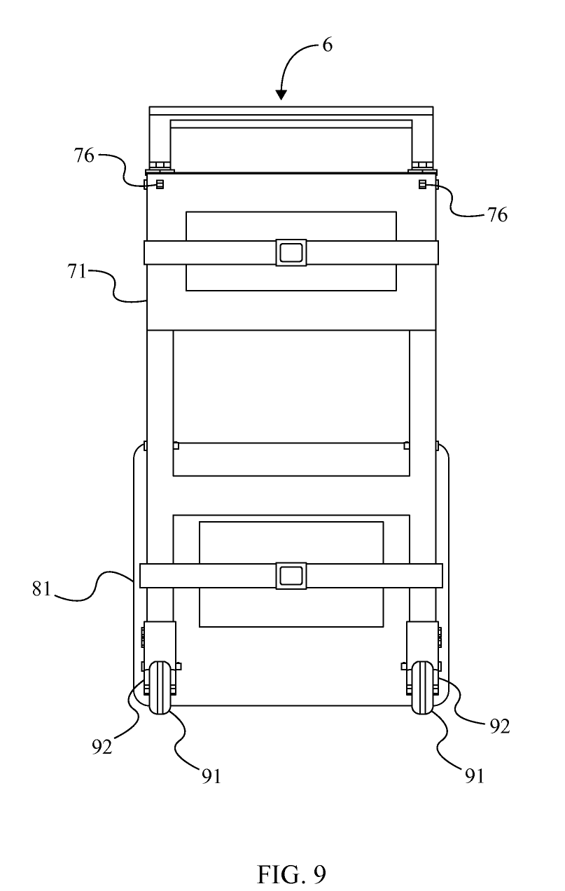

A collapsed configuration of the present invention exists wherein the back plate 71 is positioned parallel to the left telescoping leg 1 and the right telescoping leg 2 as can be observed in FIG. 7. The back plate assembly 7 of the present invention further comprises a back locking assembly 72, a left back pin 75, and a right back pin 76. The left plate mount 73 is attached to the left telescoping leg 1 by way of the left back pin 75. The right plate mount 74 is attached to the right telescoping leg 2 by way of the right plate mount 74. The use of the left back pin 75 and the right back pin 76 allows the entire back plate assembly 7 to be removed from the rest of the present invention. The present invention can function as a standalone hand truck, and in such a usage situation, the back plate assembly 7 is unnecessary and can be removed. The left plate mount 73 and the right plate mount 74 are releasably engaged with the back plate 71 by way of a locking assembly. The locking assembly is present on both the left plate mount 73, and the right plate mount 74, and is intended to hold the back plate 71 in the collapsed configuration which is shown in FIG. 9. Referencing FIG. 7, with the back plate 71 being aligned parallel to the left telescoping leg 1 and the right telescoping leg 2, the side profile of the present invention is much slimmer and more compact. This compact configuration allows the present invention to be more easily transported or stored when the present invention is not in use.

A functional configuration of the present invention exists wherein the back plate 71 is in a functional position. The back plate assembly 7 again comprises the back locking assembly 72, the left back pin 75, and the right back pin 76. The left plate mount 73 is attached to the left telescoping leg 1 by way of the left back pin 75. The right plate mount 74 is attached to the left telescoping leg 1 by way of the right back pin 76. Again, the left back pin 75 and the right back pin 76 allow the back plate assembly 7 to be completely removed from the rest of the present invention when necessary. The back locking assembly 72 is disengaged from the back plate 71 in the functional configuration of the present invention. Furthermore, the back plate 71 is aligned perpendicular to the left telescoping leg 1 and the right telescoping leg 2. This positioning can be observed in FIG. 1, and is intended to allow the back plate 71 to rest flush on top of some luggage item which the present invention is mounted to. Contact between the back plate 71 and the top of the luggage item provides vertical support for the present invention, thereby transferring the weight loading of the present invention, and any objects placed thereon, into the luggage item. Furthermore, the back plate 71 is immediately adjacent to the back stop 13 found on the upper section 11. The purpose of the back stop 13 is to provide a physical barrier which prevents the back plate 71 from rotating past ninety degrees relative to the left telescoping leg 1 and the right telescoping leg 2.

The functional configuration of the present invention exists wherein the base plate 81 is in a functional position. The base plate assembly 8 further comprises a base locking mechanism 82. The base locking mechanism 82 is mechanically integrated into the hinged connection between the base plate 81, the left base mount 83, and the right base mount 84. The base plate 81 is oriented to be perpendicular to the left telescoping leg 1 and the right telescoping leg 2 as can be observed in FIG. 1. The base plate 81 is held in this position by the base locking mechanism 82. In the functional configuration, the perpendicular orientation of the base plate 81 provides a significant surface area upon which objects can be placed. This subsequently allows the present invention to effectively transport other objects, such as luggage items. Objects are supported by the base plate 81, and the loading forces are transferred into the other components of the present invention by the appropriate connections; the user can easily move the objects either by virtue of the left wheel assembly 9 and the right wheel assembly 10, or the present invention being mounted to a luggage item which has an already existing wheel mechanism.

The collapsed configuration of the present invention exists wherein the base plate 81 is in a collapsed position. The base plate assembly 8 again further comprises the base locking mechanism 82. The base locking mechanism 82 is mechanically integrated into the hinged connection between the base plate 81, the left base mount 83, and the right base mount 84. The base plate 81 is oriented to be adjacent and parallel to the left telescoping leg 1 and the right telescoping leg 2 as can be observed in FIG. 7. This positioning drastically reduces the side profile of the present invention, thereby allowing the present invention to be more easily transported or stored when not in use.

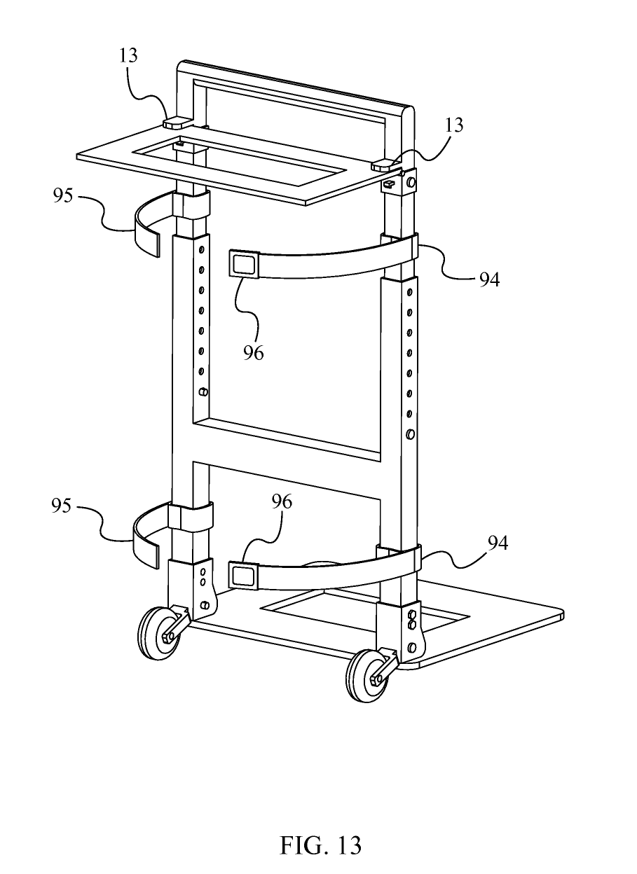

A plurality of adjustable straps 93 of the present invention exist where each of the plurality of adjustable straps 93 comprises a left strap 94, a right strap 95, and a locking mechanism 96. The left strap 94 is attached to the left telescoping leg 1, and the right strap 95 is attached to the right telescoping leg 2. The left strap 94 and the right strap 95 are selectively coupled to each other by the locking mechanism 96, thereby forming a closed loop. Referencing FIG. 1, the plurality of adjustable straps 93 can be seen with the left strap 94 coupled to the right strap 95. Referencing FIG. 13, the plurality of adjustable straps 93 can be seen with the left strap 94 decoupled from the right strap 95. The purpose of the plurality of adjustable straps 93 is to allow the present invention to be further secured to a luggage item. In usage, the left telescoping leg 1 and the right telescoping leg 2 are brought parallel and adjacent to the luggage item, and then the left strap 94 and the right strap 95 are wrapped around the luggage item. The left strap 94 and the right strap 95 are then coupled together by way of the locking mechanism 96; thereby forming a temporary attachment between the present invention, and the luggage item.

Although the invention has been explained in relation to its preferred embodiment, it is to be understood that many other possible modifications and variations can be made without departing from the spirit and scope of the invention as hereinafter claimed.

What is claimed is:

1. A luggage mountable hand truck comprises:
a left telescoping leg;
a right telescoping leg;
a stabilizing bar;
a handle;
a back plate assembly;
a base plate assembly;
a plurality of adjustable straps;
the left telescoping leg and the right telescoping leg being parallel and offset from each other;
the stabilizing bar being perpendicularly connected in between the left telescoping leg and the right telescoping leg;
the handle being perpendicularly connected in between the left telescoping leg and the right telescoping leg;
the back plate assembly comprises a back plate, a left plate mount, and a right plate mount;
the left plate mount being attached to the left telescoping leg;
the right plate mount being attached to the right telescoping leg;
the back plate hingedly connected to both the left plate mount and the right plate mount;
the base plate assembly comprises a base plate, a left base mount, and a right base mount;
the left base mount being connected to the left telescoping leg;
the right base mount being connected to the right telescoping leg; and
the base plate being hingedly connected to both the left base mount and the right base mount.

2. The luggage mountable hand truck as claimed in claim 1 comprises:
the left base mount and the handle being positioned opposite of each other along the left telescoping leg;
the stabilizing bar being positioned in between the left base mount and the handle;
the left back plate mount being positioned in between the handle and the stabilizing bar;

3. The luggage mountable hand truck as claimed in claim 1 comprises:
the right base mount and the handle being positioned opposite of each other along the right telescoping leg;
the stabilizing bar being positioned in between the right base mount and the handle; and
the right back plate mount being positioned in between the handle and the stabilizing bar.

4. The luggage mountable hand truck as claimed in claim 1 comprises:
the left telescoping leg and the right telescoping leg each comprise an upper section, and a lower section;
the upper section comprises an upper pin hole and a back stop;
the lower section comprises a central channel, and a plurality of lower pin holes;
the upper pin hole traversing perpendicularly through the upper section;
the upper pin hole being aligned parallel to the handle;
the back stop being positioned perpendicularly to the upper section, and adjacent to the back plate;
the upper pin hole being offset from the back stop along the upper section;
the central channel traversing into the lower section;
the central channel being positioned along the lower section;
the plurality of lower pin holes traversing through the lower section parallel to the stabilizing bar;
the plurality of lower pin holes traversing through the lower section and the central channel;
the plurality of lower pin holes being evenly distributed along the central channel;
the upper section traversing into the central channel of the lower section; and
a desired lower pin hole from the plurality of lower pin holes being aligned concentrically with the upper pin hole.

5. The luggage mountable hand truck as claimed in claim 4 comprises:
a left adjustment pin; and
the left adjustment pin being positioned into the desired lower pin hole and the upper pin hole of the left telescoping leg.

6. The luggage mountable hand truck as claimed in claim 4 comprises:
a right adjustment pin; and
the right adjustment pin being positioned into the desired lower pin hole and the upper pin hole of the left telescoping leg.

7. The luggage mountable hand truck as claimed in claim 1 comprises:
the left wheel assembly and the right wheel assembly each comprise a wheel and a wheel mount;
the wheel rotatably mounted into the wheel mount;
the wheel being positioned adjacent to the base plate;
the wheel mount of the left wheel assembly being attached to the left base mount; and
the wheel mount of the right wheel assembly being attached to the right base mount.

8. The luggage mountable hand truck as claimed in claim 1 comprises:
wherein the back plate is in a collapsed configuration;
the back plate assembly further comprises a back locking assembly, a left back pin, and a right back pin;
the left plate mount and the right plate mount being releasably engaged with the back plate by the locking assembly; and
the back plate being adjacent and parallel to the left telescoping leg and the right telescoping leg.

9. The luggage mountable hand truck as claimed in claim 1 comprises:
wherein the back plate is in a functional configuration;
the back plate assembly further comprises a back locking assembly, a left back pin, and a right back pin;
the back locking assembly being disengaged from the back plate;
the back plate being perpendicular to the left telescoping leg and the right telescoping leg; and
the back plate being pressed against the back stop.

10. The luggage mountable hand truck as claimed in claim 1 comprises:
wherein the base plate is in a functional configuration;
the base plate assembly further comprises a base locking mechanism;
the base locking mechanism being mechanically integrated into the hinged connection between the base plate and the left base mount and the right base mount; and
the base plate being perpendicularly held to the left telescoping leg and the right telescoping leg by the base locking mechanism.

11. The luggage mountable hand truck as claimed in claim 1 comprises:
wherein the base plate is in a collapsed configuration;
the base plate assembly further comprises a base locking mechanism;
the base locking mechanism being mechanically integrated into the hinged connection between the base plate and the left base mount and the right base mount; and
the base plate being adjacent and parallel to the left telescoping leg and the right telescoping leg.

12. The luggage mountable hand truck as claimed in claim 1 comprises:
each of the plurality of adjustable straps comprises a left strap, a right strap, and a locking mechanism;
the left strap attached adjacent to the left telescoping leg;
the right strap attached adjacent to the right telescoping leg; and
the left strap and the right strap being selectively coupled to each other by the locking mechanism.

13. A luggage mountable hand truck comprises:
a left telescoping leg;
a right telescoping leg;
a stabilizing bar;
a handle;
a back plate assembly;
a base plate assembly;
a plurality of adjustable straps;
the left telescoping leg and the right telescoping leg being parallel and offset from each other;
the stabilizing bar being perpendicularly connected in between the left telescoping leg and the right telescoping leg;
the handle being perpendicularly connected in between the left telescoping leg and the right telescoping leg;
the back plate assembly comprises a back plate, a left plate mount, and a right plate mount;
the left plate mount being attached to the left telescoping leg;
the right plate mount being attached to the right telescoping leg;
the back plate hingedly connected to both the left plate mount and the right plate mount;
the base plate assembly comprises a base plate, a left base mount, and a right base mount;
the left base mount being connected to the left telescoping leg;
the right base mount being connected to the right telescoping leg;
the base plate being hingedly connected to both the left base mount and the right base mount;
the left base mount and the handle being positioned opposite of each other along the left telescoping leg;
the stabilizing bar being positioned in between the left base mount and the handle;
the left back plate mount being positioned in between the handle and the stabilizing bar;
the right base mount and the handle being positioned opposite of each other along the right telescoping leg;
the stabilizing bar being positioned in between the right base mount and the handle; and
the right back plate mount being positioned in between the handle and the stabilizing bar.
each of the plurality of adjustable straps comprises a left strap, a right strap, and a locking mechanism;
the left strap attached adjacent to the left telescoping leg;
the right strap attached adjacent to the right telescoping leg; and
the left strap and the right strap being selectively coupled to each other by the locking mechanism.

14. The luggage mountable hand truck as claimed in claim 13 comprises:
the left telescoping leg and the right telescoping leg each comprise an upper section, and a lower section;
the upper section comprises an upper pin hole and a back stop;
the lower section comprises a central channel, and a plurality of lower pin holes;
the upper pin hole traversing perpendicularly through the upper section;
the upper pin hole being aligned parallel to the handle;
the back stop being positioned perpendicularly to the upper section, and adjacent to the back plate;
the upper pin hole being offset from the back stop along the upper section;
the central channel traversing into the lower section;
the central channel being positioned along the lower section;
the plurality of lower pin holes traversing through the lower section parallel to the stabilizing bar;
the plurality of lower pin holes traversing through the lower section and the central channel;
the plurality of lower pin holes being evenly distributed along the central channel;
the upper section traversing into the central channel of the lower section; and
a desired lower pin hole from the plurality of lower pin holes being aligned concentrically with the upper pin hole.

15. the luggage mountable hand truck as claimed in claim 14 comprises:
a left adjustment pin;
a right adjustment pin;
the left adjustment pin being positioned into the desired lower pin hole and the upper pin hole of the left telescoping leg; and
the right adjustment pin being positioned into the desired lower pin hole and the upper pin hole of the left telescoping leg.

16. The luggage mountable hand truck as claimed in claim 13 comprises:
the left wheel assembly and the right wheel assembly each comprise a wheel and a wheel mount;
the wheel rotatably mounted into the wheel mount;
the wheel being positioned adjacent to the base plate;
the wheel mount of the left wheel assembly being attached to the left base mount; and
the wheel mount of the right wheel assembly being attached to the right base mount.

17. The luggage mountable hand truck as claimed in claim 13 comprises:
wherein the back plate is in a collapsed configuration;
the back plate assembly further comprises a back locking assembly, a left back pin, and a right back pin;
the left plate mount and the right plate mount being releasably engaged with the back plate by the locking assembly; and
the back plate being adjacent and parallel to the left telescoping leg and the right telescoping leg.

18. The luggage mountable hand truck as claimed in claim 13 comprises:
wherein the back plate is in a functional configuration;
the back plate assembly further comprises a back locking assembly, a left back pin, and a right back pin;
the back locking assembly being disengaged from the back plate;
the back plate being perpendicular to the left telescoping leg and the right telescoping leg; and
the back plate being pressed against the back stop.

19. The luggage mountable hand truck as claimed in claim 13 comprises:
wherein the base plate is in a functional configuration;
the base plate assembly further comprises a base locking mechanism;
the base locking mechanism being mechanically integrated into the hinged connection between the base plate and the left base mount and the right base mount; and
the base plate being perpendicularly held to the left telescoping leg and the right telescoping leg by the base locking mechanism.

20. The luggage mountable hand truck as claimed in claim 13 comprises:
wherein the base plate is in a collapsed configuration;
the base plate assembly further comprises a base locking mechanism; and
the base locking mechanism being mechanically integrated into the hinged connection between the base plate and the left base mount and the right base mount; and
the base plate being adjacent and parallel to the left telescoping leg and the right telescoping leg.
